(19) United States
(12) Patent Application Publication
(10) Pub. No.: US 2014/0341568 A1
(43) Pub. Date: Nov. 20, 2014

(54) High-Throughput Network Traffic Monitoring through Optical Circuit Switching and Broadcast-and-Select Communications

(71) Applicant: Sodero Networks, Inc., Cranbury, NJ (US)

(72) Inventors: Yueping ZHANG, Princeton, NJ (US); Lei XU, Princeton Junction, NJ (US)

(73) Assignee: SODERO NETWORKS, INC., Cranbury, NJ (US)

(21) Appl. No.: 14/281,017

(22) Filed: May 19, 2014

Related U.S. Application Data
(60) Provisional application No. 61/825,292, filed on May 20, 2013.

(51) Int. Cl. H04B 10/079; H04J 14/02

(52) U.S. Cl. CPC H04B 10/0795; H04B 10/0793; H04J 14/0227; H04J 14/0212
USPC 398/34

(57) ABSTRACT

A network traffic collecting and monitoring system includes a traffic processing and dispatching module that pre-processes network traffic received from traffic tapping modules. A traffic collecting module receives and consolidates the network traffic and sends the network traffic to higher-layer applications. A controller dynamically configures the traffic processing and dispatching module to achieve optimal measurement accuracy and network coverage.

### CROSS-REFERENCE TO RELATED APPLICATIONS

This application claims priority to U.S. Provisional Patent Application No. 61/825,292 filed May 20, 2013, which is incorporated herein by reference.

This patent application is related to U.S. Provisional Patent Application No. 61/719,026 filed Oct. 26, 2012, now U.S. application Ser. No. 14/057,133 filed Oct. 18, 2013, published as U.S. Patent Application Publication No. 2014/0119728. Substantive portions of U.S. Provisional Patent Application No. 61/719,026 are attached hereto in an Appendix to the present application. U.S. Provisional Patent Application No. 61/719,026 is incorporated herein by reference.

### BACKGROUND OF THE INVENTION

The present invention relates generally to computer network monitoring and management system design. More particularly, the present invention relates to high-throughput network traffic collection and processing systems. Furthermore, methods for monitoring, analyzing the network traffic and determining the pairwise network traffic matrix are described.

The present invention pursues optical switching and wavelength division multiplexing technologies for applications in data center networks, and describes a completely new hardware and software design, which significantly reduces the cost and improves the scalability of the system.

### SUMMARY OF THE INVENTION

In one embodiment, a network traffic collecting and monitoring system includes a traffic processing and dispatching module that pre-processes network traffic received from one or more traffic tapping modules. A traffic collecting module receives and consolidates the network traffic and sends the network traffic to higher-layer applications. A controller dynamically configures the traffic processing and dispatching module to achieve optimal measurement accuracy and network coverage.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there are shown in the drawings embodiments that are presently preferred. It should be understood, however, that the invention is not limited to the precise arrangements and instrumentalities shown.

In the drawings:

FIG. 1 illustrates an anatomy of a prior art server cluster;

FIG. 2 illustrates the architecture of a network monitoring system in accordance with the present invention;

FIG. 3 is an exemplary deployment scenario of the network monitoring system of FIG. 2;

FIG. 4 is an exemplary architecture of a traffic fusion module of the network monitoring system of FIG. 2;

FIG. 5 is a flowchart of the functionality of the central controller of the network monitoring system of FIG. 2;

FIG. 6 is an exemplary architecture of a traffic collection and processing module of the network monitoring system of FIG. 2;

FIG. 7 is an exemplary design of a data receive module of the traffic collection and processing module of FIG. 6; and

FIG. 8 illustrates the workflow when the application of FIG. 7 fetches a data from the network interfaces.

FIG. 9 is a system diagram of a data center network;

FIG. 10 is a network topology of 4-ary 2-cube architecture implemented in the data center network of FIG. 9;

FIG. 11 is a network topology of a (3, 4, 2)-ary 3-cube architecture implemented in the data center network of FIG. 9;

FIG. 12 is a system architecture of an optical switched data center network;

FIG. 13 is a wavelength selective switching unit architecture using a broadcast-and-select communication mechanism;

FIG. 14 is a wavelength selective switching unit architecture using the point-to-point communication mechanism according to the prior art;

FIG. 15 is a flowchart of steps for determining routing of flows;

FIG. 16 is a logical graph of a 4-array 2-cube network using the wavelength selective switching unit of FIG. 13;

FIG. 17 is a bipartite graph representation of the logical graph of FIG. 16;

FIG. 18 is a flowchart of steps for provisioning bandwidth and assigning wavelengths on each link in the broadcast-and-select based system of FIG. 13;

FIG. 19 is a flowchart of steps for minimizing wavelength reassignment in the broadcast-and-select based system of FIG. 13; and

FIG. 20 is a flowchart of steps for provisioning bandwidth and assigning wavelengths on each link in the point-to-point based prior art system of FIG. 14.

### DETAILED DESCRIPTION OF THE INVENTION

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

The preferred invention will be described in detail with reference to the drawings. The figures and examples below are not meant to limit the scope of the present invention to a single embodiment, but other embodiments are possible by way of interchange of some or all of the described or illustrated elements. Moreover, where some of the elements of the present invention can be partially or fully implemented using known components, only portions of such known components that are necessary for an understanding of the present invention will be described, and a detailed description of other portions of such known components will be omitted so as not to obscure the invention.

In general, the present invention relates to network traffic monitoring and system management schemes, specifically in server clusters. According to some aspects, the described high-throughput traffic monitoring system is built upon a non-intrusive, application-transparent network traffic duplication scheme, which is based on an optical broadcast-and-select communication mechanism described in U.S. Provisional Patent Application No. 61/719,026 (attached hereto as Appendix A) which is incorporated herein by reference. This communication mechanism is able to duplicate network traffic onto multiple optical fibers with no additional overhead in the data traffic. According to further aspects, the described traffic monitoring system is able to selectively monitor network packet streams coming from different data transmission or switch ports and subsets of the network traffic according to specific criteria, such that minimum packet losses and maximum network coverage are achieved. By utilizing wavelength division multiplexing (WDM) technologies, the described traffic monitoring system is able to have a fine-grained control of selecting the subsets of network traffic to monitor. By analyzing the collected network traffic data, the described monitoring system is able to obtain a network traffic matrix, to infer application dependency, and to conduct fault diagnosis and other management tasks.

A method of dynamically scheduling network traffic monitoring to optimize the monitoring coverage and accuracy includes prioritizing network traffic based on volume, optimizing the port monitoring sequence, and reconstructing the incomplete monitoring data is described. Furthermore, a method of network traffic monitoring that collects the network traffic through optical signal broadcasting from the network transmission and switching ports, and selects the monitoring channels at allocated time slots, and generates the network traffic pattern matrix is described.

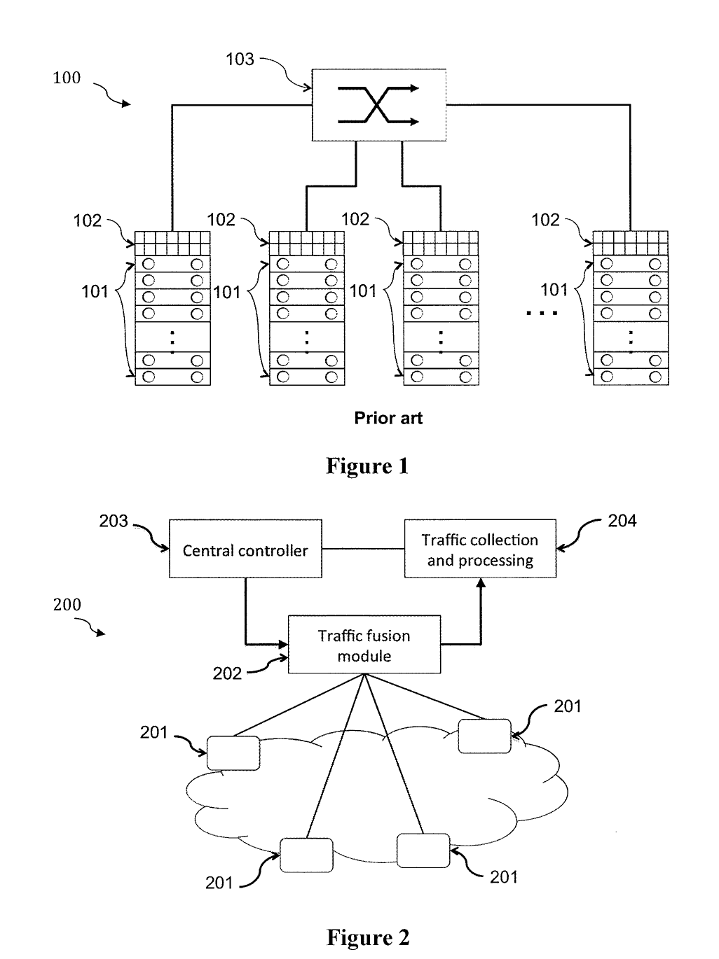

Referring to the figures, wherein like reference numerals indicate corresponding parts in the various figures, FIG. 1 illustrates the components of a typical prior art server cluster 100. Specifically, the most basic elements of a data center are servers, a plurality of which are disposed in server racks 101. Each server rack 101 is equipped with a top-of-rack switch (ToR) 102, which typically connects servers located on the same server rack 101 and further interconnects with a cluster switch 103. A cluster switch 103 is composed of one or multiple layers of switches such that every server in the cluster can reach every other server in the cluster.

All servers communicate with all other servers in the cluster through the ToR 102 and the cluster switch 103. Many management tasks, such as network intrusion detection, network fault diagnosis, and application dependency discovery, depend on an effective and efficient network monitoring mechanism. In some emerging network technologies, such as software defined networking, network monitoring is of high importance in providing key information for network optimization and interconnection reconfiguration. However, in a production server cluster, the network traffic volume between servers may easily reach 1 Gb/s and even 10 Gb/s, making network traffic monitoring challenging.

Referring to FIG. 2, an apparatus 200 for monitoring network traffic in a server cluster is shown. The apparatus includes at least one high-throughput low-overhead network traffic tapping module 201. The network traffic tapping module 201 uses an optical broadcast-and-select communication mechanism. A traffic fusion module 202 consolidates, filters, and/or selects the traffic to be monitored. A central controller 203 adaptively reconfigures the traffic fusion module 202 to achieve optimal monitoring coverage and efficiency. A traffic collection and processing module 204 receives and analyzes the network traffic collected by the traffic fusion module 202 and forwards the traffic to a higher-layer application or other system components for further processing. The central controller 203 may communicate with the traffic collection and processing module 204 to facilitate its control functionalities. Each of the four components is now described in further detail.

Network Traffic Tapping Module 201

The network traffic tapping module 201 employs an optical signal duplication mechanism, which is able to generate a copy of the signal transmitted on an incoming optical fiber onto multiple outgoing fiber channels. One such exemplary is an optical power splitter, which splits the incoming optical signal into multiple output ports. However other optical signal duplication mechanisms are known to those skilled in the art. Typically, such signal duplication devices are passive, requiring minimum power consumption to achieve the functionality. These devices are also transparent to the bit rate, allowing such a device to be deployed at low-bandwidth edge networks or high-bandwidth core networks.

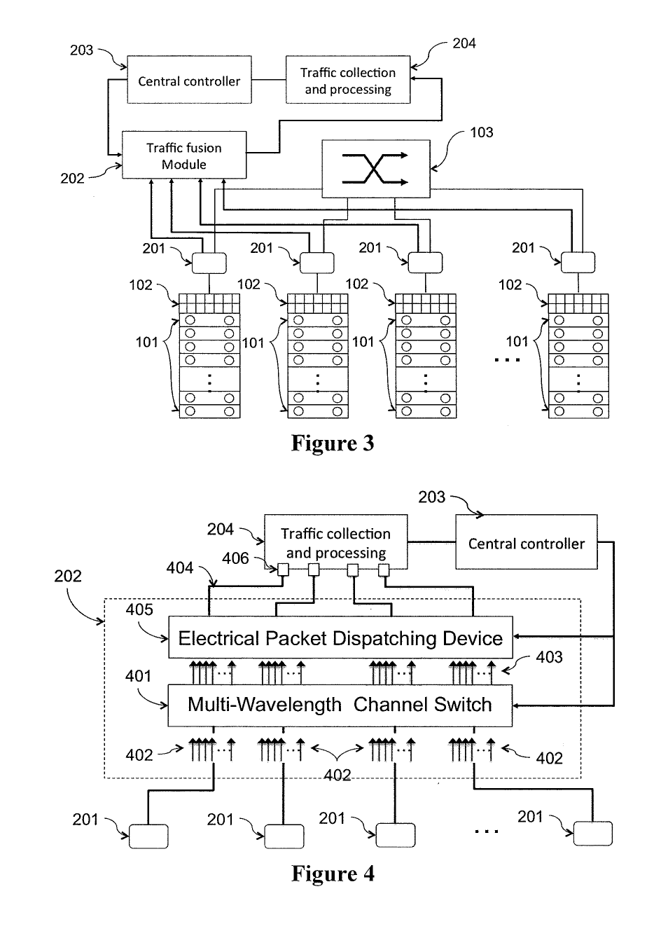

FIG. 3 is an exemplary deployment scenario of the network traffic-tapping module 201. As shown in FIG. 3, at each top-of-rack switch 102, one traffic-tapping module 201 is deployed at the upstream optical link connected to the higher layer switches (e.g., aggregation or core switches). Each traffic-tapping module 201 has an optical fiber, which carries duplicated network traffic, connected to the traffic fusion module 202. After passing through the traffic fusion module 202, the network traffic is fed into the traffic collection and processing module 204 and later is forwarded to higher-layer applications. Similarly to FIG. 2, the traffic fusion module 202 is dynamically controlled by the central controller 203. As those skilled in the art will understand, the traffic tapping modules 201 are not necessarily deployed at the upstream links of the top-of-rack switches, but can be deployed at any other vantage point in the system.

Traffic Fusion Module 202

The traffic collection module 204 typically maintains a limited number of receiving ports, and therefore limited data processing capability. To accommodate the processing and port count limitations of the traffic collection module 204, duplicate network traffic generated by the traffic-tapping module 201 is first directed to the traffic fusion module 202 instead of directly to the traffic collection module 204. The main functionality of the fusion module 202 is to consolidate, sample, and/or filter network traffic such that optimal network coverage and operational efficiency is achieved.

An exemplary architecture of the traffic fusion module 202 is shown in FIG. 4. One component of the traffic fusion module 202 is a multi-wavelength optical channel switch 401. The optical channel switch 401 may be implemented in a plurality of ways. For example, the optical channel switch 401 may be implemented with wavelength selective switching (WSS) utilizing wavelength division multiplexing (WDM) technologies or optical space switching (e.g., microelectromechanical system or MEMS and optical switching matrix). Compared to the MEMS-based approaches, an advantage of the WSS-based approach is that the traffic fusion module 202 has much finer-grained control of selecting the subset of network traffic to be monitored. However, other technologies for implementing the optical channel switches 401 are known to those skilled in the art, and are within the scope of this disclosure.

A multi-wavelength optical channel switch 401 takes as input multiple channels of optical signals 402 and generates multiple channels of output optical signals 403. Each of the connecting fiber ports of the input optical signals 402 can carry multiple wavelength channels, while each of the output connecting fiber ports of the output signals 403 carries only one wavelength channel. In addition, the composition of signals carried on each individual channel may change over time. The dynamic signal composition is managed by the central controller 203, which decides what input traffic goes to what output channel based on the network traffic characteristics, and realizes such decisions by initiating control commands to the multi-wavelength optical channel switch 401.

The output 403 of the multi-wavelength optical channel switch 401 is further fed into an electrical packet-dispatching device 405, which conducts network packet header look-up and forwards the packets to the corresponding outgoing ports. The electrical packet-dispatching device 405 may be implemented in a plurality of ways. For example, the switches can be implemented using conventional address-based layer-2 or layer-3 switches, rule-based switches (such as Openflow switches), or dedicated flow-processing units equipped with a purpose-built chipset. However, other technologies for implementing the electrical packet-dispatching device 405 are known to those skilled in the art, and are within the scope of this disclosure. The packet-dispatching configurations (i.e., what packets go to which outgoing ports) are not static, but can be dynamically changed by the central controller 203 such that minimum packet loss and optimal load balancing is achieved.

The outputs of the electrical packet-dispatching device 405 are sent to the traffic collection and processing module 204 for further processing.

### Central Controller 203

The central controller 203 communicates with the components of the traffic fusion module 202, the optical channel switch 401 and the electrical packet-dispatching device 405. The optical channel switch 401 receives the multiple channels of input optical signals 402 from each network traffic-tapping module 201 and selectively forwards different channels of optical signals 402 onto different output channels 403. Since the input optical signals may have certain conflicts in their physical properties (e.g., wavelength contention in wavelength division multiplexing), the controller 203 communicates with the optical channel switch 401 to guarantee conflict-free input signal admission. In addition, the controller 203 also configures what channels of optical signals 402 are forwarded onto what output channels 403 such that the maximum amount of network traffic is captured by the traffic fusion module 202.

A plurality of methods may be utilized by the controller 203 to achieve this goal. For instance, the controller 203 can simply use a round-robin-like scheduling scheme (i.e., all channels are ordered and monitored in a circular order) to rotate the optical signal channels 402 to be monitored, such that every channel is monitored for an equal-length period of time. The controller 203 can also use an importance sampling based scheduling mechanism, in which the controller 203 allocates more monitoring time to signal channels 402 of higher priority (i.e., higher traffic volume, carrying more relevant traffic, or the like). The controller 203 can also leverage other physical properties or practical application requirements, such as correlation among traffic, parity of the transmitting/receiving ports of the optical transceiver, and contention between optical wavelengths, to improve the monitoring efficiency and accuracy. Other technologies for further optimizing the monitoring performance of the traffic fusion module 202 are known to those skilled in the art and are within the scope of this disclosure.

The packet-dispatching device 405 takes as input the multi-channel optical signals 403 and redistributes the signals onto the output channels 404, which further feed into the traffic collection and processing module 204. Since the traffic carried in the output channels 404 changes over time, the traffic volume of an output signal 404 may exceed the physical capacity of the input interface of the traffic collection and processing module 204, resulting in packet loss and incomplete packet capture. Thus, the controller 203 continuously monitors the traffic volume of each input signal to the traffic collection and processing module 204, and dynamically adjusts the distribution of the optical signals 403 on the output channels 404, such that packet losses at all the input interfaces of the traffic collection and processing module 204 are prevented or minimized.

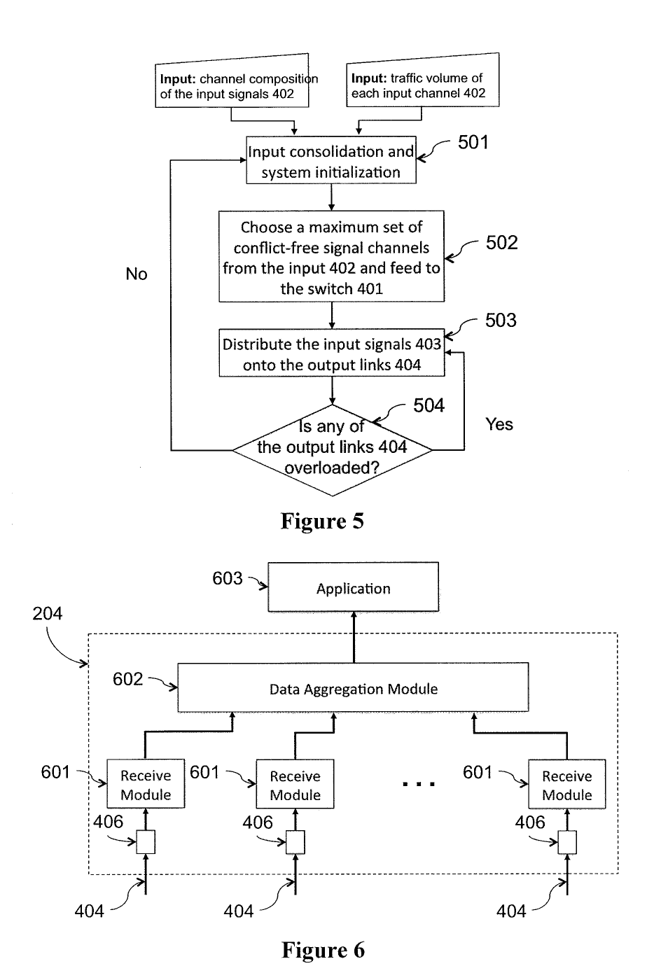

FIG. 5 is a flowchart showing functionality of the central controller 203 described above. The controller 203 takes as input the composition of signals of the input channels 402 and their traffic volume. At step 501, the controller 203 consolidates the input and initializes or updates the system variables. At step 502, based on the signal composition of the input 402, the controller 203 decides for each input channel 402 what signals are admitted into the traffic fusion module 202. At step 503, the controller 203 distributes the admitted signals onto the output links 404. At step 504, based on the traffic volume of the admitted signals, the controller 203 determines whether or not the total traffic volume of any of the output links 404 exceeds the physical capacity of the corresponding receiving interface 406 of the traffic collection and processing module 204. If yes, the controller 203 invokes step 503 to redistribute the output signals. Otherwise, the controller 203 loops back to step 501 and processes the new input data, which were periodically sent to the controller 203 from the traffic collection and processing module 204.

### Traffic Collection and Processing Module 204

The traffic collection and processing module 204 and the controller 203 may be collocated on the same physical device, or they may be deployed separately. An exemplary architecture of the processing module 204 is shown in FIG. 6. The processing module 204 has multiple input interfaces 406, each of which is connected to one output port of the data fusion module 202. The data received from each input interface 406 are further processed by a receive module 601. Then, the data aggregation module 602 consolidates the data processed by all the receive modules 601 and sends as input to the upper-layer applications 603 for further processing.

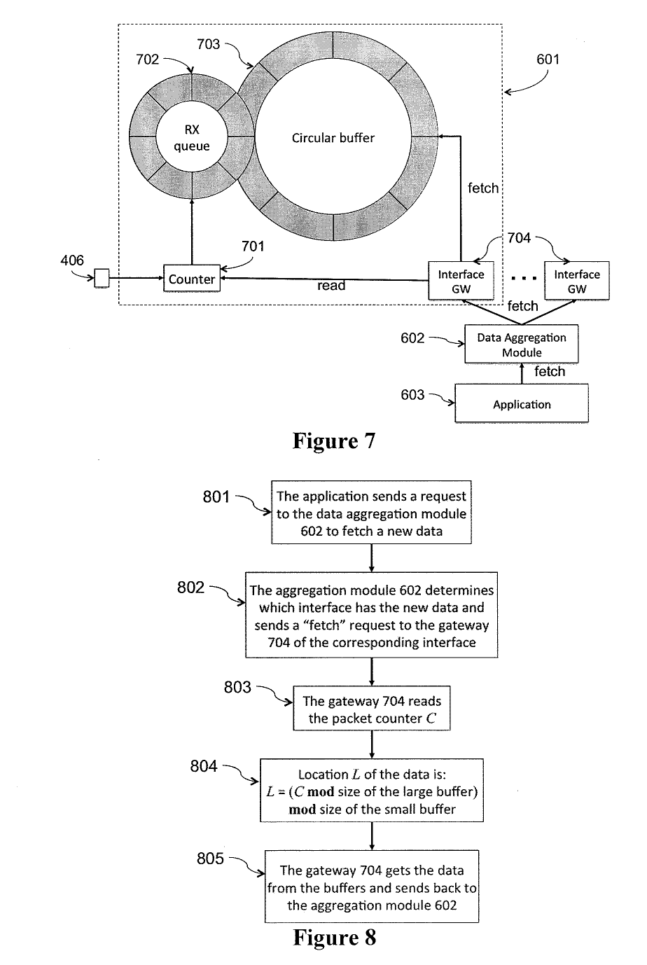

The data received from each interface 406 are first buffered in a receive queue within the receive module 601. Then the higher-layer application 603 fetches data and removes the data from the receive queue. For high-speed network interfaces 406 (i.e., 10 Gbps or higher), it is very common that the application 603 cannot fetch data fast enough such that the receive queue is overflowed, resulting in packet losses. To address this issue, the preferred invention utilizes a two-stage circular buffer, as illustrated in FIG. 7. A circular buffer is a data structure in which buffer entries are arranged in a circle. There are two key pointers that are maintained in a circular buffer, the “head” and the “tail” pointers. Namely, the head pointer records the position of the next buffer entry to be fetched and the tail pointer records the location of the last entry. Whenever after an entry in the buffer is fetched, the header pointer slides to the next entry. Whenever after adding one entry to the buffer, the entry is added after the one pointed by the tail pointer and the tail pointer slides to the position of the newly added entry. If adding a new entry results in the event that the tail pointer points to the position of the head pointer, the new entry is discarded. This event is called “buffer overflow.” A circular buffer can be implemented in a plurality way, including array and linked list.

Referring to FIG. 7, when a network packet enters the interface 406, it is first placed after the tail of a circular receive queue 702, the tail pointer slides to the address of the newly added packet, and the counter 701 is incremented by the size of the packet. When the queue 702 is full, the tail of the queue 702 is copied to the tail of the second-level circular buffer 703. When the buffer 703 is full (i.e., when the tail and head pointers of the second-level buffer 703 meet), the tail of the buffer is dropped. Compared to a single-stage circular buffer that is commonly used in the device drivers of high-speed network interface cards (NIC), the two-stage circular buffer in the traffic receive module 601 is especially valuable in scenarios where, due to complicated application analytics and operations, the data processing speed of the high-layer applications does not match the high-throughput network transmission.

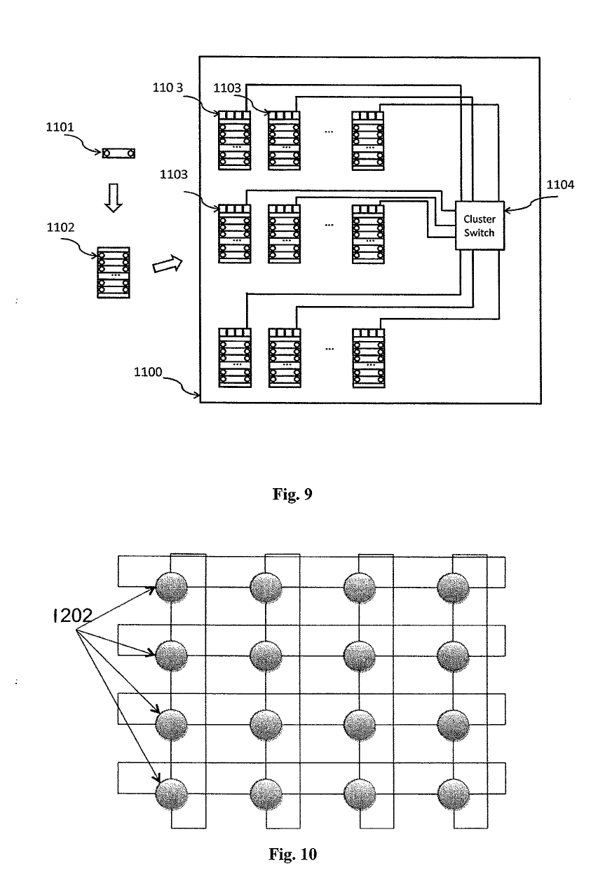

FIG. 8 illustrates a process by which the application 603 fetches data from the network interfaces 406. In step 801, the application 603 first sends a request to the data aggregation module 602, which in step 802 determines which interface 406 to fetch the data and sends a “fetch” request to the gateway module 704 of the corresponding interface. In step 803, the gateway module 704 reads the packet counter 701. In step 804, the gateway 704 calculates the position L of the data to read, which equals to:

L=(C mod Rₛ)mod Rₗ,

Where Rₛ and Rₗ are the size of the small 702 and large 703 circular buffers, respectively. Then, in step 805, the gateway 704 gets the data from the buffer and returns it to the aggregation module 602 and further the application 603.

While one exemplary design and implementation of the traffic collection and processing module 204 has been described, other technologies for implementing the traffic collection and processing module 204 are known to those skilled in the art, and are within the scope of this disclosure.

The described apparatus and the related methods enable efficiently collecting, capturing, and processing high-throughput network traffic in a large-scale data center or enterprise network. The utilized broadcast-and-select communication mechanism enables zero-overhead network traffic duplication and tapping. Furthermore, the reconfigurable multi-wavelength channel switch 401 and the packet dispatching device 405 embedded in the traffic fusion module 202 allows the central controller 203 to dynamically select the set of traffic to be monitored such that minimum packet losses and maximum monitoring coverage are achieved.

### APPENDIX

### Specification of U.S. Provisional Application No. 61/719,026

### Title

### Method and Apparatus for Implementing a Multi-Dimensional Optical Circuit Switching Fabric

### PART I: BACKGROUND OF THE INVENTION

Embodiments of the present invention relate generally to computer network switch design and network management. More particularly, the present invention relates to scalable and self-optimizing optical circuit switching networks, and methods for managing such networks.

Inside traditional data centers, network load has evolved from local traffic (i.e., intra-rack or intra-subnet communications) into global traffic (i.e., all-to-all communications). Global traffic requires high network throughput between any pair of servers. The conventional over-subscribed tree-like architectures of data center networks provide abundant network bandwidth to the local areas of the hierarchical tree, but provide scarce bandwidth to the remote areas. For this reason, such conventional architectures are unsuitable for the characteristics of today's global data center network traffic.

Various next-generation data center network switching fabric and server interconnect architectures have been proposed to address the issue of global traffic. One such proposed architecture is a completely flat network architecture, in which all-to-all non-blocking communication is achieved. That is, all servers can communicate with all the other servers at the line speed, at the same time. Representatives of this design paradigm are the Clos-network based architectures, such as FatTree and VL2. These systems use highly redundant switches and cables to achieve high network throughput. However, these designs have several key limitations. First, the redundant switches and cables significantly increase the cost for building the network architecture. Second, the complicated interconnections lead to high cabling complexity, making such designs infeasible in practice. Third, the achieved all-time all-to-all non-blocking network communication is not necessary in practical settings, where high-throughput communications are required only during certain periods of time and are constrained to a subset of servers, which may change over time.

A second such proposed architecture attempts to address these limitations by constructing an over-subscribed network with on-demand high-throughput paths to resolve network congestion and hotspots. Specifically, c-Through and Helios design hybrid electrical and optical network architectures, where the electrical part is responsible for maintaining connectivity between all servers and delivering traffic for low-bandwidth flows and the optical part provides on-demand high-bandwidth links for server pairs with heavy network traffic. Another proposal called Flyways is very similar to c-Through and Helios, except that it replaces the optical links with wireless connections. These proposals suffer from similar drawbacks.

Compared to these architectures, a newly proposed system, called OSA, pursues an all-optical design and employs optical switching and optical wavelength division multiplexing technologies. However, the optical switching matrix or Microelectromechanical systems (MEMS) component in OSA significantly increases the cost of the proposed architecture and more importantly limits the applicability of OSA to only small or medium sized data centers.

Accordingly, it is desirable to provide a high-dimensional optical circuit switching fabric with wavelength division multiplexing and wavelength switching and routing technologies that is suitable for all sizes of data centers, and that reduces the cost and improves the scalability and reliability of the system. It is further desirable to control the optical circuit switching fabric to support high-performance interconnection of a large number of network nodes or servers.

### PART II: SUMMARY OF THE INVENTION

In one embodiment, an optical switching system is described. The system includes a plurality of interconnected wavelength selective switching units. Each of the wavelength selective switching units is associated with one or more server racks. The interconnected wavelength selective switching units are arranged into a fixed structure high-dimensional interconnect architecture comprising a plurality of fixed and structured optical links. The optical links are arranged in a k-ary n-cube, ring, mesh, torus, direct binary n-cube, indirect binary n-cube, Omega network or hypercube architecture.

In another embodiment, a broadcast/select optical switching unit is described. The optical switching unit includes a multiplexer, an optical power splitter, a wavelength selective switch and a demultiplexer. The multiplexer has a plurality of first input ports. The multiplexer is configured to combine a plurality of signals in different wavelengths from the plurality of first input ports into a first signal output on a first optical link. The optical power splitter has a plurality of first output ports. The optical power splitter is configured to receive the first signal from the first optical link and to duplicate the first signal into a plurality of duplicate first signals on the plurality of first output ports. The duplicated first signal is transmitted to one or more second optical switching units. The wavelength selective switch has a plurality of second input ports. The wavelength selective switch is configured to receive one or more duplicated second signals from one or more third optical switching units and to output a third signal on a second optical link. The one or more duplicated second signals are generated by second optical power splitters of the one or more third optical switching units. The demultiplexer has a plurality of second output ports. Each second output port has a distinct wavelength. The demultiplexer is configured to receive the third signal from the second optical link and to separate the third signal into the plurality of second output ports.

An optical switching fabric comprising a plurality of optical switching units. The plurality of optical switching units are arranged into a fixed structure high-dimensional interconnect architecture. Each optical switching unit includes a multiplexer, a wavelength selective switch, an optical power combiner and a demultiplexer. The multiplexer has a plurality of first input ports. The multiplexer is configured to combine a plurality of signals in different wavelengths from the plurality of first input ports into a first signal output on a first optical link. The wavelength selective switch has a plurality of first output ports. The wavelength selective switch is configured to receive the first signal from the first optical link and to divide the first signal into a plurality of second signals. Each second signal has a distinct wavelength. The plurality of second signals are output on the plurality of first output ports. The plurality of second signals are transmitted to one or more second optical switching units. The optical power combiner has a plurality of second input ports. The optical power combiner is configured to receive one or more third signals having distinct wavelengths from one or more third optical switching units and to output a fourth signal on a second optical link. The fourth signal is a combination of the received one or more third signals. The demultiplexer has a plurality of second output ports. Each second output port has a distinct wavelength. The demultiplexer is configured to receive the fourth signal from the second optical link and to separate the fourth signal into the plurality of second output ports based on their distinct wavelengths.

### PART III: DETAILED DESCRIPTION OF THE PREFERRED EMBODIMENTS

Certain terminology is used in the following description for convenience only and is not limiting. The words “right”, “left”, “lower”, and “upper” designate directions in the drawings to which reference is made. The terminology includes the above-listed words, derivatives thereof, and words of similar import. Additionally, the words “a” and “an”, as used in the claims and in the corresponding portions of the specification, mean “at least one.”

The present invention will be described in detail with reference to the drawings. The figures and examples below are not meant to limit the scope of the present invention to a single embodiment, but other embodiments are possible by way of interchange of some or all of the described or illustrated elements. Moreover, where some of the elements of the present invention can be partially or fully implemented using known components, only portions of such known components that are necessary for an understanding of the present invention will be described, and a detailed description of other portions of such known components will be omitted so as not to obscure the invention.

Referring to the drawings in detail, wherein like reference numerals indicate like elements throughout, FIG. 9 is a system diagram, which illustrates the typical components of a data center 1100 in accordance with the present invention. The most basic elements of a data center are servers 1101, a plurality of which may be arranged into server racks 1102. Each server rack 1102 is equipped with a top-of-rack switch (ToR) 1103. All of the ToRs 1103 are further interconnected with one or multiple layers of cluster (e.g., aggregation and core) switches 1104 such that every server 1101 in the data center 1100 can communicate with any one of the other servers 1101. The present invention is directed to the network switching fabric interconnecting all ToRs 1103 in the data center 1100.

Referring to FIG. 12, a high-dimensional optical switching fabric 1401 for use with the data center 1100 of FIG. 9 is shown. The switching fabric 1401 includes a plurality of wavelength selective switching units 1403 interconnected using a high-dimensional data center architecture 1404. The high-dimensional data center architecture 1404 is achieved by coupling multiple wavelength selective switching units 1403 with fixed and structured fiber links to form a high-dimensional interconnection architecture. Each wavelength selective switching unit 1403 is associated with, and communicatively coupled to, a server rack 1102 through a ToR 1103. The high-dimensional data center architecture 1404 preferably employs a generalized k-ary n-cube architecture, where k is the radix and n is the dimension of the graph. The design of the wavelength selective switching units 1403 and the associated procedures of the network manager 1402 are not limited to k-ary n-cube architectures. Other architectures that are isomorphic to k-ary n-cubes, including rings, meshes, tori, direct or indirect binary n-cubes, Omega network, hypercubes, etc may also be implemented in the high-dimensional data center architecture 404, and are within the scope of this disclosure.

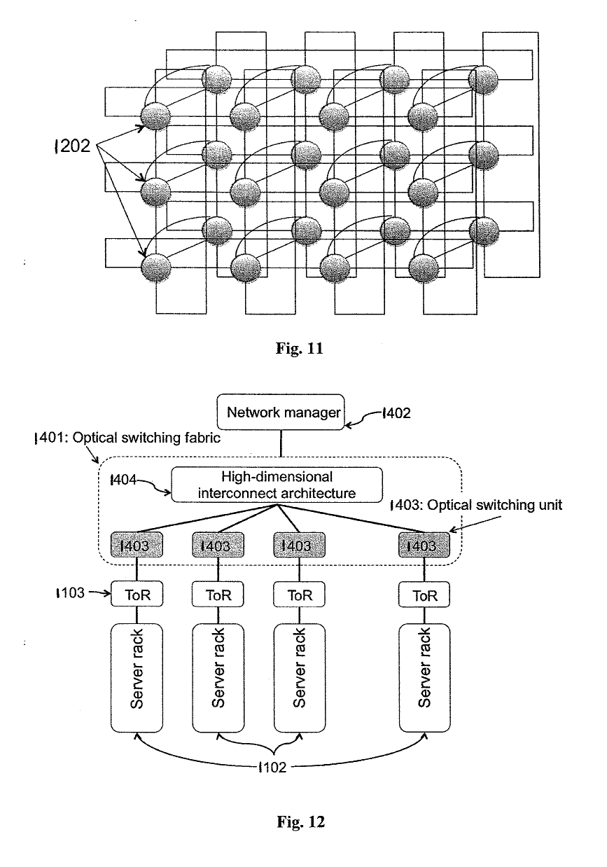

The k-ary n-cube architecture is denoted by Cnk, where n is the dimension and vector k=<k1, k2, . . . , kn> denotes the number of elements in each dimension. Referring to FIGS. 10 and 11, examples of a 4-ary 2-cube (i.e., k=<4,4> and n=2) and (3, 4, 2)-ary 3-cube (i.e., k=<3,4,2> and n=3), respectively, are shown. Each node 1202 in FIGS. 10 and 11 represents a server rack 1102 (including a ToR 1103) and its corresponding wavelength selective switching unit 1403. Other examples of architectures are not shown for sake of brevity, but those skilled in the art will understand that such alternative architectures are within the scope of this disclosure.

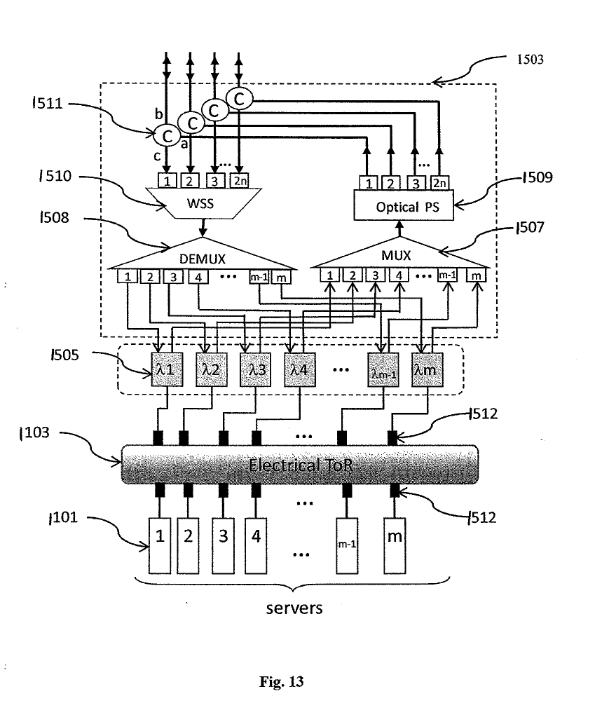

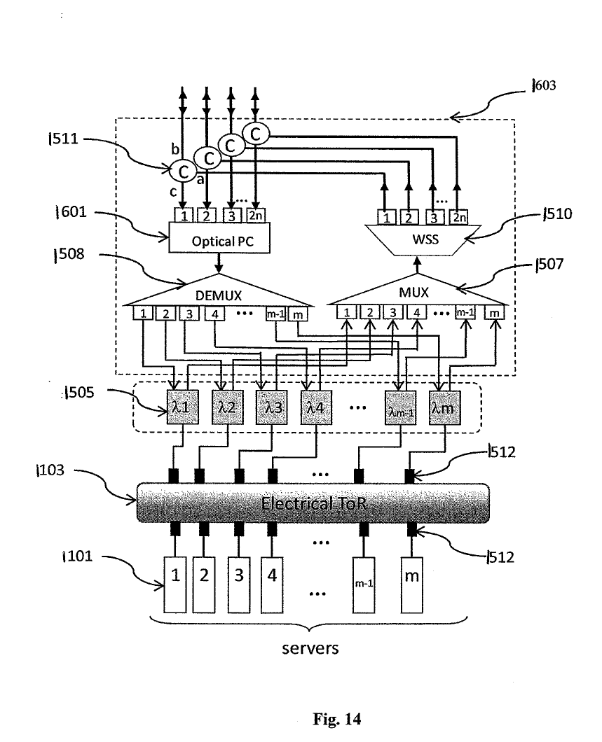

Two designs of the wavelength selective switching unit 1403 of FIG. 12 are described with reference to FIG. 13 and prior art FIG. 14. The designs of FIGS. 13 and 14 vary based on whether the underlying communication mechanism is broadcast-and-select or point-to-point. Furthermore, a broadcast-and-select based wavelength selective switching unit 1503 may be symmetric or asymmetric, depending on the requirements and constraints of practical settings.

### Symmetric Architecture

A symmetric architecture of a broadcast-and-select based wavelength selective switching unit 1503 connected to ToR 1103 and servers 1101 is shown in FIG. 13. Each electrical ToR 1103 has 2m downstream ports. Downstream ports usually have lower line speed and are conventionally used to connect to the servers 1101. The higher-speed upstream ports are described with respect to the asymmetric architecture below.

In the symmetric wavelength selective switching unit 1503 of FIG. 13, half of the 2m downstream ports of electrical ToR 1103 are connected to rack servers 1101 and the other half are connected to m optical transceivers 1505 at different wavelengths, λ1, λ2, . . . λm. In typical applications, the optical transceivers 1505 have small form-factors, such as the SFP (Small Form Factor Pluggable) type optical transceivers, at different wavelengths following typical wavelength division multiplexing (WDM) grids. Each optical transceiver 1505, typically consisting of a SFP type optical module sitting on a media converter (not shown), has one electrical signal connecting port 1512 (such as an electrical Ethernet port), one optical transmitting port and one optical receiving port. The bit rate of the optical transceivers 1505 at least matches or is higher than that of the Ethernet port 1512. For instance, if the Ethernet port 1512 supports 1 Gb/s signal transmission, the bit rate of each optical transceiver 1505 can be 1 Gb/s or 2.5 Gb/s; if the Ethernet port 1512 is 10 Gb/s, the bit rate of each optical transceiver 1505 is preferably 10 Gb/s as well. This configuration assures non-blocking communication between the servers 1101 residing in the same server rack 1102 and the servers 1101 residing in all other server racks 1102.

Logically above the ToR 1103 is a broadcast-and-select type design for the wavelength selective switching units 1503. The wavelength selective switching units 1503 are further interconnected via fixed and structured fiber links to support a larger number of server inter communications. Each wavelength selective switching unit 1503 includes an optical signal multiplexing unit (MUX) 1507, an optical signal demultiplexing unit (DEMUX) 1508 each with m ports, a 1×2n optical wavelength selective switch (WSS) 1510, a 1×2n optical power splitter (PS) 1509, and 2n optical circulators (c) 1511. The optical MUX 1507 combines the optical signals at different wavelengths for transmission in a single fiber. Typically, two types of optical MUX 1507 devices can be used. In a first type of optical MUX 1507, each of the input ports does not correspond to any specific wavelength, while in the second type of optical MUX 1507, each of the input ports corresponds to a specific wavelength. The optical DEMUX 1508 splits the multiple optical signals in different wavelengths in the same fiber into different output ports. Preferably, each of the output ports corresponds to a specific wavelength. The optical PS 509 splits the optical signals in a single fiber into multiple fibers. The output ports of the optical PS 1509 do not have optical wavelength selectivity. The WSS 1510 can be dynamically configured to decide the wavelength selectivity of each of the multiple input ports. As for the optical circulators 1511, the optical signals arriving via port “a” come out at port “b”, and optical signals arriving via port “b” come out at port “c”. The optical circulators 1511 are used to support bidirectional optical communications in a single fiber. However, in other embodiments, optical circulators 1511 are not required, and may be replaced with two fibers instead of a single fiber.

In the wavelength selective switching unit 1503 of FIG. 13, the optical transmitting port of the transceiver 1505 is connected to the input port of the optical MUX 1507. The optical MUX 1507 combines m optical signals from m optical transceivers 1505 into a single fiber, forming WDM optical signals. The output of optical MUX 507 is connected to the optical PS 1509. The optical PS 1509 splits the optical signals into 2n output ports. Each of the output ports of the optical PS 1509 has the same type of optical signals as the input to the optical PS 1509. Therefore, the m transmitting signals are broadcast to all of the output ports of the optical PS 1509. Each of the output ports of optical PS 1509 is connected to port “a” of an optical circulator 1511, and the transmitting signal passes port “a” and exits at port “b” of optical circulator 1511.

In the receiving part of the wavelength selective switching unit 1503, optical signals are received from other wavelength selective switching units 1503. The optical signals arrive at port “b” of optical circulators 1511, and leave at port “c”. Port “c” of each optical circulator 1511 is coupled with one of the 2n ports of WSS 1510. Through dynamic configuration of the WSS 1510 with the algorithms described below, selected channels at different wavelengths from different server racks 1102 can pass the WSS 1510 and be further demultiplexed by the optical DEMUX 1508. Preferably, each of the output ports of optical DEMUX 1508 corresponds to a specific wavelength that is different from other ports. Each of the m output ports of the optical DEMUX 1508 is preferably connected with the receiving port of the optical transceiver 1505 at the corresponding wavelength.

Inter-rack communication is conducted using broadcast and select communication, wherein each of the outgoing fibers from the optical PS 1509 carries all the m wavelengths (i.e., all outgoing traffic of the rack). At the receiving end, the WSS 1510 decides what wavelengths of which port are to be admitted, and then forwards them to the output port of the WSS 1510, and the output of the WSS 1510 that is connected to the optical DEMUX 508. The optical DEMUX 1508 separates the WDM optical signals into the individual output port, which is connected to the receiving port of the optical transceivers 1505. Each ToR 1103 combined with one wavelength selective switching unit 1503 described above constitutes a node 1202 in FIGS. 10 and 11. All of the nodes 1202 are interconnected following a high-dimensional architecture 1404. All the wavelength selective switching units 1503 are further controlled by a centralized or distributed network manager 1402. The network manager 1402 continuously monitors the network situation of the data center 1100, determines bandwidth demand of each flow, and adaptively reconfigures the network to improve the network throughput and resolve hot spots. These functionalities are realized through a plurality of procedures, described in further detail below.

Asymmetric Architecture

The asymmetric architecture broadcast-select architecture achieves 100% switch port utilization, but at the expense of lower bisection bandwidth. The asymmetric architecture is therefore more suitable than the symmetric architecture for scenarios where server density is of major concern. In an asymmetric architecture, the inter-rack connection topology is the same as that of the symmetric counterpart. The key difference is that the number of the ports of a ToR 1103 that are connected to servers is greater than the number of the ports of the same ToR 1103 that are connected to the wavelength selective switching unit 1403. More specifically, each electrical ToR 1103 has m downstream ports, all of which are connected to servers 1101 in a server rack 102. Each ToR 1103 also has u upstream ports, which are equipped with u small form factor optical transceivers at different wavelength, λ1, λ2, . . . λu. In a typical 48-port GigE switch with four 10 GigE upstream ports, for instance, we have 2 m=48 and u=4.

Logically above the ToR 1103 is the wavelength selective switching unit 1503, which consists of a multiplexer 1507 and a demultipexer 1508, each with u ports, a 1×2n WSS, and a 1×2n power splitter (PS) 1509. The transmitting ports and receiving ports of the optical transceivers are connected to the corresponding port of optical multiplexer 1507 and demultiplexer 1508, respectively. The output of optical multiplexer 1507 is connected to the input of optical PS 1509, and the input of the optical demultiplexer 1508 is connected to the output of the WSS 1510. Each input port of the WSS 1510 is connected directly or through an optical circulator 1511 to an output port of PS of the wavelength selective switching unit 1403 in another rack 1102 via an optical fiber. Again, the optical circulator 1511 may be replaced by two fibers.

In practice, it is possible that the ports, which are originally dedicated for downstream communications connected with servers 1101, can be connected to the wavelength selective switching unit 1403, together with the upstream ports. In this case, the optical transceivers 1505 may carry a different bit rate depending on the link capacity of the ports they are connected to. Consequently, the corresponding control software will also need to consider the bit rate heterogeneity while provisioning network bandwidth, as discussed further below.

In both the symmetric and asymmetric architectures, a network manager 1402 optimizes network traffic flows using a plurality of procedures. These procedures will now be described in further detail.

### Procedure 1: Estimating Network Demand

The first procedure estimates the network bandwidth demand of each flow. Multiple options exist for performing this estimation. One option is to run on each server 1101 a software agent that monitors the sending rates of all flows originated from the local server 1101. Such information from all servers 1101 in a data center can be further aggregated and the server-to-server traffic demand can be inferred by the network manager 1402. A second option for estimating network demand is to mirror the network traffic at the ToRs 1103 using switched port analyzer (SPAN) ports. After collecting the traffic data, network traffic demand can be similarly inferred as in the first option. The third option is to estimate the network demand by emulating the additive increase and multiplicative decrease (AIMD) behavior of TCP and dynamically inferring the traffic demand without actually capturing the network packets. Based on the deployment scenario, a network administrator can choose the most efficient mechanism from these or other known options.

### Procedure 2: Determining Routing.

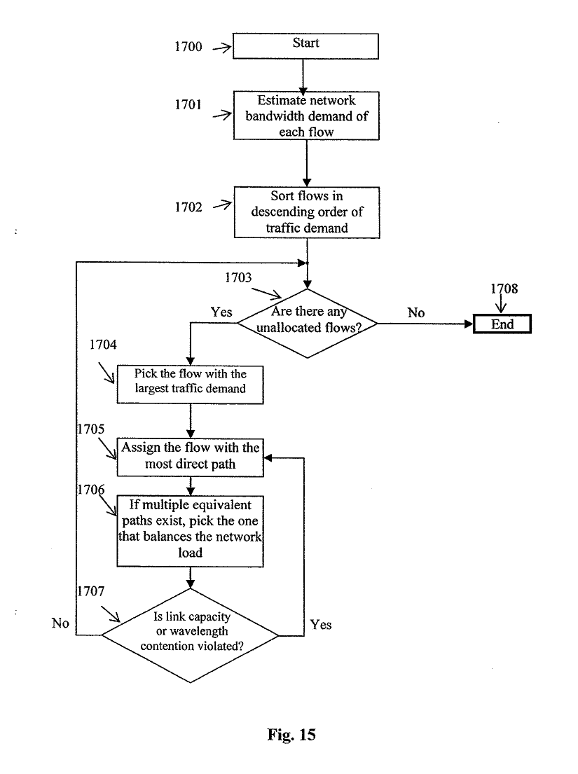

In the second procedure, routing is allocated in a greedy fashion based on the following steps, as shown in the flow chart of FIG. 15. The process begins at step 1700 and proceeds to step 1701, where the network manager 1402 identifies the source and destination of all flows, and estimates the network bandwidth demand of all flows. At step 1702, all flows are sorted in a descending order of the network bandwidth demand of each flow. At step 1703, it is checked whether all of the flows have been allocated a path. If all flows have been allocated a path, the procedure terminates in step 1708. Otherwise, the network manager 1402 identifies the flow with the highest bandwidth demand in step 1704 and allocates the most direct path to the flow in step 1705. If multiple equivalent direct paths of a given flow exist, in step 1706, the network manager chooses the path that balances the network load. The network manager 1402 then checks whether the capacities of all links in the selected path are exceeded in step 1707. Link capacity is preferably decided by the receivers, instead of the senders, which broadcast all the m wavelengths to all the 2n direct neighbors.

If the capacity of at least one of the links in the selected path is exceeded, the network manager goes back to step 1705 and picks the next most direct path and repeats steps 1706 and 1707. Otherwise, the network manager 402 goes to step 1704 to pick the flow with the second highest bandwidth demand and repeats steps 1705 through 1707.

In a physical network, each server rack 1102 is connected to another server rack 1102 by a single optical fiber. But logically, the link is directed. From the perspective of each server 1101, all the optical links connecting other optical switching modules in both the ingress and egress directions carry all the m wavelengths. But since these m wavelengths will be selected by the WSS 1510 at the receiving end, these links can logically be represented by the set of wavelengths to be admitted.

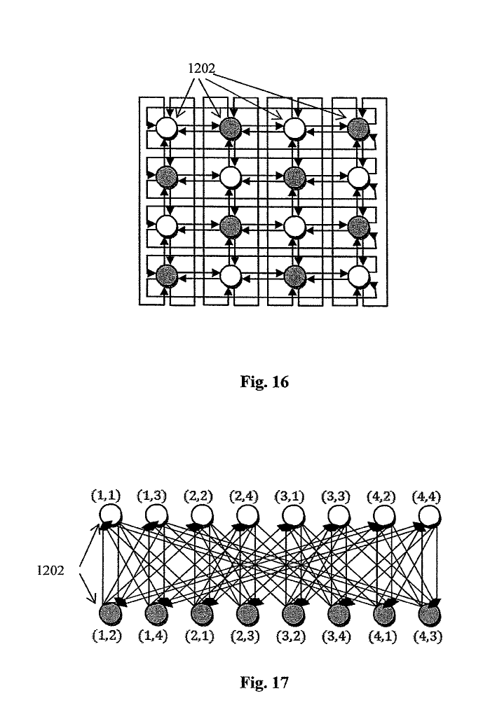

The logical graph of a 4-ary 2-cube cluster is illustrated in FIG. 16. Each directed link in the graph represents the unidirectional transmission of the optical signal. For ease of illustration, the nodes 1102 are indexed from 1 to k in each dimension. For instance, the i-th element in column j is denoted by (i,j). All nodes in {(i,j)|i=1, 3, . . . , k−1, j=2, 4, . . . , k} and all nodes in {(i,j)|i=2, 4, . . . , k, j=1, 3, . . . , k−1} are shown in WHITE, and all the remaining nodes are shaded. As long as k is even, such a perfect shading always exists.

Next, all the WHITE nodes are placed on top, and all GREY nodes are placed on the bottom, and a bipartite graph is obtained, as shown in FIG. 17. In the graph of FIG. 17, all directed communications are between WHITE and GREY colored nodes, and no communications occur within nodes of the same color. This graph property forms the foundation of the key mechanisms of the present system, including routing and bandwidth provisioning.

### Procedure 3: Provisioning Link Bandwidth and Assigning Wavelengths.

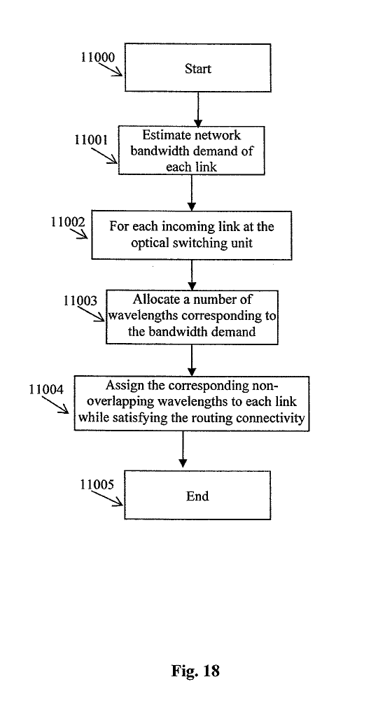

In this procedure, the network manager 1402 provisions the network bandwidth based on the traffic demand obtained from Procedure 1 and/or Procedure 2, and then allocates wavelengths to be admitted at different receiving WSSs 1510, based on the following steps, as shown in the flowchart of FIG. 18. The process begins at step 11000, and proceeds to step 11001 where the network manager 1402 estimates the bandwidth demand of each optical link based on the bandwidth demand of each flow. In step 11002, the network manager 1402 determines for each link the number of wavelengths necessary to satisfy the bandwidth demand for that link. In step 11003, the network manager 1402 allocates a corresponding number of wavelengths to each link such that there is no overlap between the sets of wavelengths allocated to all the input optical links connected to the same wavelength selective switch 1510.

In step 11004, since at the WSS 1510, the same wavelength carried by multiple optical links cannot be admitted simultaneously (i.e., the wavelength contention problem), the network manager 1402 needs to ensure that for each receiving node, there is no overlap of wavelength assignment across the 2n input ports. Thereafter, the process ends at step 11005.

### Procedure 4: Minimizing Wavelength Reassignment.

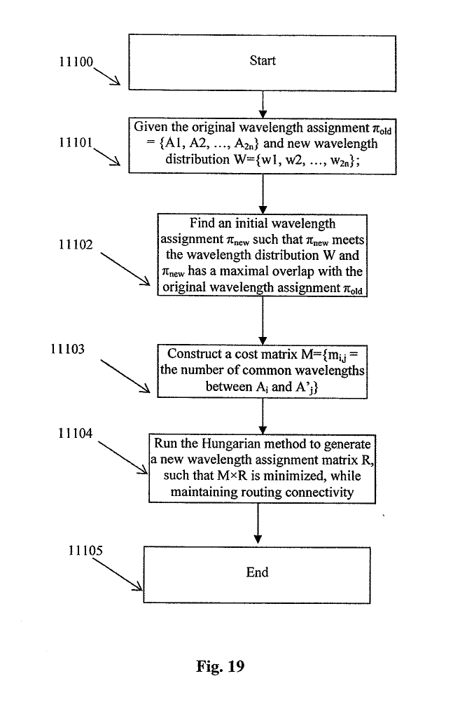

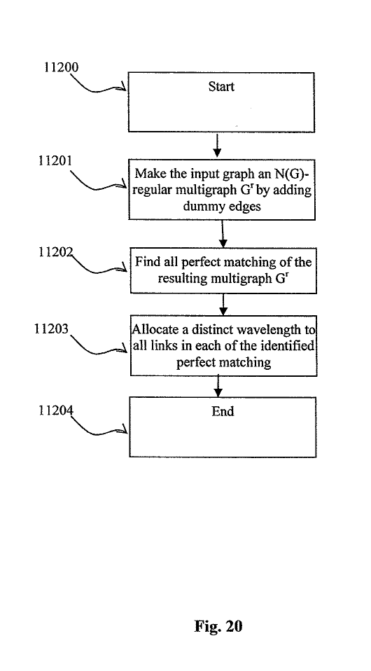

Procedure 3 does not consider the impact of changes of wavelength assignment, which may disrupt network connectivity and lead to application performance degradation. Thus, in practice, it is desirable that only a minimum number of wavelength changes are performed to satisfy the bandwidth demands. Therefore, it is desirable to maximize the overlap between the old wavelength assignment πold and the new assignment anew. The classic Hungarian method can be adopted as a heuristic to achieve this goal. The Hungarian method is a combinatorial optimization algorithm to solve assignment problems in polynomial time. This procedure is described with reference to the flow chart of FIG. 19. The process begins at step 1100, and proceeds to step 11101, at which the network manager 1402 first identifies the old wavelength assignment π_{old}={A1, A2, . . . , A2n} (where Ai denotes the set of wavelengths assigned to link i) and wavelength distribution (i.e., the number of wavelength required for each link) under the new traffic matrix. At step 11102, the network manager 1402 finds a new wavelength assignment π_{new}={A′1, A′2, . . . , A′2n} that satisfies the wavelength distribution and has as much overlap with πold as possible. In step 11103, the network manager 1402 constructs a cost matrix M, whose each element mij is equal to the number of common wavelengths between sets Ai and A′j. Finally, in step 1104, the network manager 1402 generates a new wavelength assignment matrix R (where

$${r}_{ij} ∈ ( 0 , 1 ) , {\sum }_{i} {r}_{ij} = 1 , and {\sum }_{j} {r}_{ij} = 1 ) ,$$

such that M×R is minimized, while maintaining routing connectivity. The process ends at step 1105.

### Procedure 5: Recovering From Network Failures.

The fifth procedure achieves highly fault-tolerant routing. Given the n-dimensional architecture, there are 2n node-disjoint parallel paths between any two ToRs 1103. Upon detecting a failure event, the associated ToRs 1103 notifies the network manager 402 immediately, and the network manager 402 informs all the remaining ToRs 1103. Each ToR 1103 receiving the failure message can easily check which paths and corresponding destinations are affected, and detour the packets via the rest of the paths to the appropriate destinations. Applying this procedure allows the performance of the whole system to degrade very gracefully even in the presence of a large percentage of failed network nodes and/or links.

### Procedure 6: Conducting Multicast, Anycast or Broadcast.

In the broadcast-and-select based design, each of the 2n egress links of a ToR 1103 carries all the m wavelengths. It is left up to the receiving WSS 1510 to decide what wavelengths to admit. Thus, multicast, anycast or broadcast can be efficiently realized by configuring the WSSs 1510 in a way that the same wavelength of the same ToR 1103 is simultaneously admitted by multiple ToRs 1103. The network manager 1402 needs to employ methods similar to the IP-based counterparts to maintain the group membership for the multicast, anycast or broadcast.

In the symmetric architecture described so far, the number of the ports of a ToR 1103 switch that are connected to servers equals the number of the ports of the same ToR 1103 that are connected to the wavelength selective switching unit 1403. This architecture achieves high bisection bandwidth between servers 1101 residing in the same server rack 1102 with the rest of the network at the expense of only 50% switch port utilization.

### Point-to-Point Communication Mechanism

The architecture of the wavelength selective switching unit 1603 used for point-to-point communication is described in U.S. Patent Application Publication Nos. 2012/0008944 to Ankit Singla and 2012/0099863 to Lei Xu, the entire disclosures of both of which are incorporated by reference herein. In the present invention, these point-to-point based wavelength selective switching units 1603 are arranged into the high-dimensional interconnect architecture 1404 in a fixed structure. In the wavelength selective switching unit 1603, as illustrated with reference to FIG. 14, each electrical ToR 1103 has 2m ports, half of which are connected to rack servers 1101 and the other half are connected with m wavelength-division multiplexing small form-factor pluggable (WDM SFP) transceivers 1505.

Logically above the ToR 1103 are the wavelength selective switching units 1603, which are further interconnected to support a larger number of inter communications between servers 1101. Each wavelength selective switching unit 1603 includes optical MUX 1507 and DEMUX 1508 each with m ports, a 1×2n optical wavelength selective switch (WSS) 1510, a 1×2n optical power combiner (PC) 601, and 2n optical circulators 1511. In operation, the optical PC 601 combines optical signals from multiple fibers into a single fiber. The WSS 1510 can be dynamically configured to decide how to allocate the optical signals at different wavelengths in the single input port into one of the different output ports. The optical circulators 1511 are used to support bi-directional optical communications using a single fiber. Again, the optical circulators 1511 are not required, as two fibers can be used to achieve the same function.

Similar to the broadcast-and-select based system described earlier, all the wavelength selective switching units 1403 are interconnected using a high-dimensional architecture and are controlled by the network manager 1402. The network manager 1402 dynamically controls the optical switch fabric following the procedures below.

Procedures 1, 2, 5 and 6 are the same as the corresponding procedures discussed above with respect to the broadcast-and-select based system.

### Procedure 3: Provisioning Link Bandwidth and Assigning Wavelengths on All Links.

The third procedure of the point-to-point architecture is described with reference to FIG. 1100, wherein N(G) is the maximum node degree of a bipartite graph G. Each node of G represents a wavelength selective switching unit 1603. The procedure begins at step 11200, and proceeds to step 11201 where the network manager 1402 first constructs a N(G)-regular (i.e., each node in the graph G has exactly degree of N(G)) multi-graph (where multiple links connecting two nodes is allowed) by adding wavelength links, each representing a distinct wavelength, to each node of G. Next, in step 11202, the network manager 1402 identifies all sets of links such that within each set there are no two links sharing a common node and the links in the same set covers all nodes in the graph G. In step 11203, the network manager 1402 assigns a distinct wavelength to all links in the same set by configuring the wavelength selective switch 1510. The process then ends at step 11204.

### Procedure 4: Minimizing Wavelength Reassignment.

This procedure is similar to Procedure 4 in the broadcast-and-select based system, finding a minimum set of wavelengths, while satisfying the bandwidth demands. This procedure first finds a new wavelength assignment πnew, which has a large wavelength overlap with the old assignment πold. Then, uses mew as the initial state and uses an adapted Hungarian method to fine-tune πnew to further increase the overlap between πnew and πold.

In the present invention, all of the wavelength selective switching units 1603 are interconnected using a fixed specially designed high-dimensional architecture. Ideal scalability, intelligent network control, high routing flexibility, and excellent fault tolerance are all embedded and efficiently realized in the disclosed fixed high dimensional architecture. Thus, network downtime and application performance degradation due to the long switching delay of an optical switching matrix are overcome in the present invention.

### End of Appendix

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An apparatus for monitoring network traffic in a server cluster comprising:
(a) one or more traffic tapping modules which receive network traffic;
(b) a traffic fusion module in communication with the one or more traffic tapping modules and adapted to select a subset of network traffic to be monitored from the network traffic received by the traffic tapping modules;
(c) a traffic collection and processing module in communication with the traffic fusion module adapted to (i) receive and analyze the subset of network traffic monitored by the traffic fusion module, and (ii) forward the network traffic to a higher-layer application for further processing; and
(d) a central controller in communication with the traffic fusion module and the traffic collection and processing module configured to dynamically reconfigure the traffic fusion module to achieve optimal monitoring coverage and efficiency.

2. The apparatus of claim 1 wherein the traffic fusion module includes a multi-wavelength optical channel switch that takes as input multiple channels of optical signals and generates as output multiple output channels of optical signals.

3. The apparatus of claim 2 wherein the central controller dynamically reconfigures the traffic fusion module by selecting what input traffic goes to what output channel based on network traffic characteristics.

4. The apparatus of claim 2 wherein the output channels of the optical channel switch are input signals to input interfaces of the traffic collection and processing module, and wherein the central controller continuously monitors traffic volume of each input signal to the input interfaces of the traffic collection and processing module and dynamically adjusts the distribution of the optical signals on the output channels, such that packet losses at the input interfaces of the traffic collection and processing module due to potential signal overcapacity at the input interfaces are prevented or minimized.

5. The apparatus of claim 2 wherein the multi-wavelength optical channel switch is implemented with wavelength selective switching.

6. The apparatus of claim 1 wherein the one or more traffic tapping modules each use an optical broadcast-and-select communication mechanism.

7. The apparatus of claim 1 wherein the one or more traffic tapping modules employ an optical signal duplication mechanism.

8. The apparatus of claim 1 further comprising:
(e) a two-stage circular buffer coupled to the traffic collection and processing module to achieve high-throughput network traffic collection and to mitigate buffer overflow caused by high network injection rate and slow application consumption.

9. An apparatus for monitoring network traffic in a server cluster comprising:
(a) one or more traffic tapping modules which receive network traffic;
(b) a traffic fusion module in communication with the one or more traffic tapping modules and adapted to select a subset of network traffic to be monitored from the network traffic received by the traffic tapping modules, the traffic fusion module including a multi-wavelength optical channel switch that takes as input multiple channels of optical signals and generates as output multiple output channels of optical signals;
(c) a traffic collection and processing module in communication with the traffic fusion module adapted to (i) receive and analyze the subset of network traffic monitored by the traffic fusion module, and (ii) forward the network traffic to a higher-layer application for further processing, wherein the output channels of the optical channel switch are input signals to input interfaces of the traffic collection and processing module; and
(d) a central controller in communication with the traffic fusion module and the traffic collection and processing module configured to continuously monitor traffic volume of each input signal to the input interfaces of the traffic collection and processing module and dynamically adjust the distribution of the optical signals on the output channels, such that packet losses at the input interfaces of the traffic collection and processing module due to potential signal overcapacity at the input interfaces are prevented or minimized.

10. The apparatus of claim 9 wherein the central controller dynamically reconfigures the traffic fusion module by selecting what input traffic goes to what output channel based on network traffic characteristics.

11. The apparatus of claim 9 wherein the multi-wavelength optical channel switch is implemented with wavelength selective switching.

12. The apparatus of claim 9 wherein the one or more traffic tapping modules each use an optical broadcast-and-select communication mechanism.

13. The apparatus of claim 9 wherein the one or more traffic tapping modules employ an optical signal duplication mechanism.
